(19) United States
(12) Patent Application Publication
(10) Pub. No.: US 2015/0325420 A1
(43) Pub. Date: Nov. 12, 2015

(54) ULTRAFAST TRANSIMPEDANCE AMPLIFIER INTERFACING ELECTRON MULTIPLIERS FOR PULSE COUNTING APPLICATIONS

(71) Applicants: Bruce Andrew Collings, Bradford (CA); Martian Daniel Dima, Richmond Hill (CA)

(72) Inventors: Bruce Andrew Collings, Bradford (CA); Martian Daniel Dima, Richmond Hill (CA)

(73) Assignee: DH Technologies Development Pt. Ltd., Singapore (SG)

(21) Appl. No.: 14/367,285

(22) PCT Filed: Nov. 21, 2012
(86) PCT No.: PCT/IB2012/002437

§ 371 Date: Jun. 20, 2014

(51) Int. Cl. H01J 49/02; H01J 49/00

(52) U.S. Cl. CPC H01J 49/025; H01J 49/0031

(57) ABSTRACT

Systems, devices, and methods are provided for an improved mass spectrometry detection system for pulse counting applications. The detector can comprise an electron multiplier and circuitry, such as a transimpedance amplifier, that allows for the gain of the detector to be decreased, which in turn leads to a pulse counting detector with a high dynamic range. In some embodiments, the detector can operate at count rates of up to about 20 million counts per second without reaching saturation. Further, the lifetime of the detector can be extended. A variety of embodiments of systems, devices, and methods in conjunction with the disclosures are provided.

### CROSS-REFERENCE TO RELATED APPLICATIONS

This application claims the benefit and priority of U.S. Provisional Application No. 61/580,349, filed Dec. 27, 2011, the entire teachings of which are incorporated herein by reference.

### FIELD

The disclosure relates to systems, devices, and methods for operating a mass spectrometry detection system, e.g., for pulse counting applications.

### BACKGROUND

Typically, systems for pulse counting applications are more sensitive at low counts but are unable to achieve the type of high counts that systems for analog counting applications can typically achieve. For example, in pulse counting detectors that comprise a chain of dynodes, the increased ion flux at the detector can lead to carbon stitching of later dynodes, which can in turn reduce the gain of the later dynodes and hence the overall gain of the detector. A bias voltage applied to the detector can be increased to compensate for the decreased gain of the later dynodes. However, as the amount of carbon stitching increases over time, progressively higher bias levels can be needed to compensate for the decreased gain. Such high bias levels can cause rapid aging of the detector, and hence reduce the detector's lifetime. Complications related to carbon stitching, rapid aging detectors, and reduced detector lifetime can also affect other types of detectors, including, by way of non-limiting example, continuous dynode detectors.

It is believed that carbon stitching also negatively impacts the count rate of detectors. Conventional systems tend to saturate at count rates above a few million counts per second in pulse counting mode, thus decreasing their accuracy and providing for a limited dynamic range. While efforts have been made to increase the dynamic range of conventional systems, including the use of multiple channels twisted together for continuous dynode detectors to allow a multiplication effect to occur over multiple channels and decreasing the impedance of a continuous dynode detector to allow for a faster replenishing of the detector bias current, such efforts have had limited success. Accordingly, improved detection systems, devices, and methods are desired.

### SUMMARY

The following summary is intended to introduce the reader to this specification but not to define any invention. One or more inventions may reside in a combination or sub-combination of the system and/or device elements or the method steps described below or in other parts herein. The inventors do not waive or disclaim their rights to any invention or inventions disclosed in this specification merely by not describing such other invention or inventions in the claims.

The embodiments described herein provide, in some aspects, a detector for use in a mass spectrometer system, where the detector can comprise an electron multiplier, a collector, and a transimpedance amplifier. The collector can be disposed downstream of the electron multiplier and can be configured to receive an electron current from the electron multiplier to generate a current signal. The transimpedance amplifier can be electrically coupled to the collector for receiving the current signal and generating a voltage signal based on the current signal. In some embodiments, the transimpedance amplifier can be configured to provide a non-unity gain. In some embodiments, the transimpedance amplifier can be configured to have an adjustable gain. In some embodiments, the detector can comprise a coupling capacitor disposed between the collector and the transimpedance amplifier to capacitively couple the current signal to the amplifier. In some embodiments, the detector can comprise a high energy conversion dynode disposed upstream of the electron multiplier and the dynode can be configured to discharge ions into the electron multiplier. The current signal can comprise a pulse current signal. In some embodiments, the detector can comprise a resistor disposed downstream of the transimpedance amplifier, where the resistor can be configured to match an input impedance of an output device to an output impedance of the transimpedance amplifier.

The embodiments described herein provide, in further aspects, a mass spectrometer system comprising an ion source, a mass analyzer, and a detector. Further, the detector can comprise an ion detection module and a transimpedance amplifier. The mass analyzer can be configured to receive a plurality of ions from the ion source. The detector can be disposed downstream of the mass analyzer and can receive ions discharged from the mass analyzer. The ion detection module can be configured to receive at least a portion of the ions discharged by the mass analyzer and to generate a current signal in response to the received ions. The transimpedance amplifier can be electrically coupled to the ion detection module to receive the current signal and to convert the current signal into a voltage signal. In some embodiments, the transimpedance amplifier can be configured to have a non-unity gain. In some embodiments, the transimpedance amplifier can be configured to have an adjustable gain. In some embodiments, the detector can be configured to operate in a pulse counting mode and can be capable of operating at a pulse counting rate of up to about 20 million counts per second without saturation. In some embodiments, the ion detection module can comprise an electron multiplier. In some embodiments, the ion detection module can comprise a high energy conversion dynode (HED) configured to receive at least a portion of ions discharged from the mass analyzer and to generate secondary ions and/or electrons in response to the received ions. The HED can be in communication with the electron multiplier so as to direct the secondary ions and/or electrons to the electron multiplier. In some embodiments, the mass analyzer can comprise a plurality of quadrupoles disposed downstream of the ion source to receive ions from the ion source.

The embodiments described herein provide, in yet further aspects, in a mass spectrometer, a method for detecting ions comprising introducing a plurality of ions discharged by a mass analyzer of the mass spectrometer into an electron multiplier to generate a pulsed current signal, and feeding the pulsed current signal to a transimpedance amplifier so as to convert the pulsed current signal into a pulsed voltage signal. In some embodiments, the electron multiplier can comprise a channel electron multiplier or continuous dynode detector. In some embodiments, the channel electron multiplier comprises a plurality of channels. In some embodiments, the electron multiplier can comprise a discrete dynode detector.

These and other features of the applicants' teachings are set forth herein.

### BRIEF DESCRIPTION OF DRAWINGS

The skilled person in the art will understand that the drawings, described below, are for illustration purposes only. The drawings are not intended to limit the scope of the applicants' teachings in any way. This invention will be more fully understood from the following description of various embodiments taken in conjunction with the accompanying drawings, in which:

FIG. 1 is a schematic representation of a mass spectrometer in accordance with some embodiments of the applicants' teachings;

FIG. 2 is a schematic representation of a detector according to some embodiments of the applicants' teachings;

FIG. 3 is a schematic representation of a detector according to some embodiments of the applicants' teachings,

FIG. 4 is a schematic representation of a detector according to some embodiments of the applicants' teachings;

FIG. 5 is a schematic representation of a detector according to some embodiments of the applicants' teachings;

FIG. 6 presents plots of measured count rate vs. true count rate for detecting an ion in a mass spectrometer by using a detector according to an embodiment of the applicants' teachings having a transimpedance amplifier and a conventional detector lacking a transimpedance amplifier;

FIG. 7 presents two measured mass spectra of four isotopic species of an ion, where one spectrum was obtained with a detector according to an embodiment of the applicants' teachings and the other was obtained using a conventional detector;

FIG. 8 is a schematic representation of a mass spectrometer according to some embodiments of the applicants' teachings; and

FIG. 9 is a schematic representation of another mass spectrometer according to some embodiments of the applicants' teachings.

### DESCRIPTION OF VARIOUS EMBODIMENTS

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the systems, devices, and methods described herein. Further, a person skilled in the art will understand instances in which like-numbered components of illustrated embodiments generally have at least some similar features, and thus within some embodiments each feature of a like-numbered component is not necessarily fully elaborated upon.

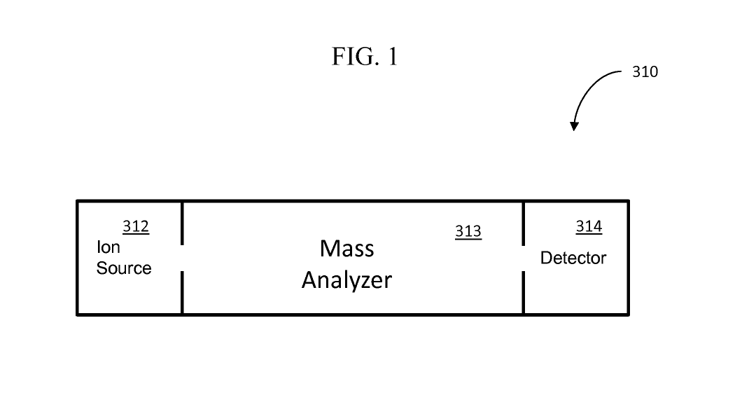

While the systems, devices, and methods described herein can be used in conjunction with many different mass spectrometry systems, a general block diagram of a mass spectrometry system is illustrated in FIG. 1 to provide a general framework for describing various embodiments of the applicants' teachings. A more detailed description of various ways in which a mass spectrometer can be configured and operated in accordance with the applicants' teachings is provided later in this description. As shown, in some embodiments, a mass spectrometer 310 can comprise an ion source 312, a mass analyzer 313, and a detector 314. The ion source 312 can emit ions that pass through the mass analyzer 313, which allows the passage of certain of those ions, e.g., ions having a mass-to-charge ratio (m/z ratio) in a selected range, to the detector 314. As discussed below, the detector 314 can be implemented according to various embodiments of the applicants' teachings.

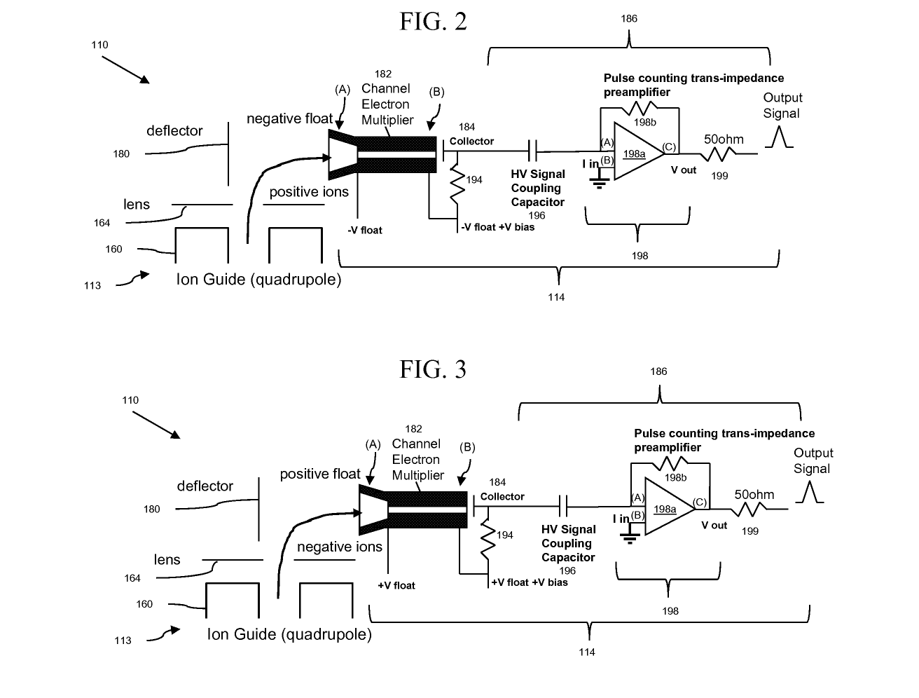

By way of example, FIGS. 2 and 3 illustrate a detector 114 according to an embodiment of the applicants' teachings for use as part of a mass spectrometer 110 in which the mass analyzer 113 comprises one or more quadrupoles, represented by a last quadrupole 160. The illustrative detector 114 can comprise an ion detection module, which as shown can comprise an electron multiplier 182 for receiving positive or negative ions and a collector 184 for receiving an electron current from the electron multiplier 182 to generate a current signal. In this illustrative embodiment, the ions exiting the last quadrupole 160 are focused via a lens 164 and are deflected via a voltage applied to a deflector electrode 180 toward the electron multiplier 182. The ions can be extracted from the mass analyzer 113 in a number of different ways, but in this illustrative embodiment, RF and DC voltages are applied to the last quadrupole 160 to determine what masses of the ions will be transmitted out of the quadrupole 160 and to the detector 114. The DC-to-RF ratio can be roughly constant for all masses, with the DC voltage being able to be tweaked to give unit resolution at all masses when scanning at unit resolution, and then the mass spectrum can be created by ramping the magnitudes of the RF and DC voltages, applied to the last quadrupole 160 which can increase with mass, to produce a mass spectrum as a function of RF amplitude that correlates to time. A faster scan speed can mean ramping the RF and DC voltages faster as well. In some embodiments, the quadrupole 160 can be configured for mass-selective axial ejection, with the different streams of ions being generated sequentially during scanning of applied auxiliary AC and/or RF confinement fields. The deflector electrode 180 can be part of the detector 114, or it can be its own separate component disposed between the mass analyzer 113 and the detector 114. Various types of electron multipliers can be used, such as discrete dynode electron multipliers and continuous dynode electron multipliers. In this illustrative embodiment, the electron multiplier 182 is a single channel continuous dynode electron multiplier configured to operate in a pulse counting mode. Alternatively, the electron multiplier can be a multiple channel electron multiplier or it can be a plurality of multipliers, each having one or more channels. By way of non-limiting example, at least one electron multiplier can comprise six channels. The illustrative single channel electron multiplier (CEM) or continuous dynode detector 182 can comprise a tube (e.g., in the form of a funnel) that comprises an electron-emissive surface, e.g., a glass coated surface where the glass is heavily doped with lead or beryllium.

As shown in FIG. 2, when the detector 114 is configured to detect positive ions, an input end (A) of the CEM 182 can be maintained at a negative float electric potential (−V) so as to attract the positive ions deflected by the deflector 180, and an output end (B) of the CEM 182 can be maintained at a less negative float potential (−V+V_{bias}) such that a desired voltage differential (i.e., V_{bias}) is applied across the tube. Conversely, as shown in FIG. 3, when the detector is configured to detect negative ions, the input end (A) of the CEM 182 can be maintained at a positive float electric potential (+V) so as to attract the negative ions deflected by the deflector 180, and the output end (B) of the CEM 182 can be maintained at a greater positive float potential (+V+V_{bias}) such that a desired voltage differential (i.e., V_{bias}) is applied across the tube.

In various embodiments the bias voltage (V_{bias}) applied across the CEM can be in a range of about 1.2 kV to about 1.4 kV. For example, in some embodiments, a negative float potential of about −6 kV can be applied to the input end (A) of the CEM 182 and a negative potential of about −5 kV to about −3 kV can be applied to its output end (B). In some other embodiments a positive float potential of about +4 kV can be applied to the input end (A) of the CEM 182 and a positive potential of about +5.8 kV to about +7 kV can be applied to its output end (B). In some cases, the application of the bias voltage across the tube can generate a substantially uniform electric field throughout the length the tube.

The ion beam can be directed into the CEM 182 such that it initially strikes near the input end (A) of the CEM 182, resulting in emission of secondary electrons, which can in turn strike other portions of the surface as they travel down the tube to cause emission of additional secondary electrons. With each subsequent strike, additional secondary electrons can be emitted, thereby amplifying the ion and/or electron current until the ions and secondary electrons reach the output end (B) of the CEM 182 and can be collected at the collector 184 as a current signal. In this illustrative embodiment, an optional resistor 194 is provided between the collector 184 and the output end (B) of the CEM 182. The resistor 194 can drain the total charge accumulated by the collector 184 to ground.

The current signal generated by the collector 184 can be fed into a voltage signal generator 186 that generates a voltage signal output. In this illustrative embodiment, the signal generator 186 can comprise a high voltage capacitor 196 that capacitively couples the current signal to a transimpedance amplifier 198. The illustrative amplifier 198 of FIGS. 2 and 3 can comprise an operational amplifier 198a with one of its input ports (A) resistively coupled to its output port (C) via a resistor 198b, and another of its input ports (B) grounded. The flow of the current signal (e.g., in the form of a current pulse in this illustrative embodiment) into the input port (A) can cause the generation of an output voltage signal (Vₒᵤₜ)(e.g., an output voltage pulse) at the output port (C) of the amplifier 198, where the magnitude of Vₒᵤₜ (and hence the gain of the amplifier 198) can be adjusted by choosing the resistance of the resistor 198b. In some embodiments, the resistor 198b can comprise a variable resistor to allow readily adjusting the gain of the transimpedance amplifier 198.

In some embodiments, the signal gain provided by the transimpedance amplifier 198 can allow reducing the gain associated with the electron multiplier, e.g., by operating the electron multiplier at a lower bias voltage, while obtaining the desired amplification of the output signal generated in response to the incident positive or negative ions. By way of example, in some embodiments, the gain associated with the electron multiplier 182 can be reduced by at least a factor of about five due to the use of the transimpedance amplifier 198. In some embodiments, such lowering of the bias voltage applied to the electron multiplier 182 can enhance its lifetime, e.g., by reducing the rate of carbon stitching. Reducing the gain of the electron multiplier 182 by lowering the bias voltage can also lead to a longer lifetime because gain reduction can result in fewer electrons being created within the multiplier 182 and less charge being depleted from the multiplier 182.

Further, in some embodiments, the use of the transimpedance amplifier 198 can allow operating the CEM 182 over a wider dynamic range. For example, as noted above, it can allow operating the CEM 182 at a lower bias voltage, thereby inhibiting saturation effects at high count rates. Typically, analog detectors can have a dynamic range that can cover high ion currents more effectively than pulse counting detectors, while pulse counting detectors can have a dynamic range that typically can extend to count rates that are lower than signals that can be effectively measured by analog detection. However, the transimpedance amplifier 198 allows the pulse counting detector 114 to be operated with a lower output current due to the lowered detector gain. This can lead to less saturation of the detector 114, and thus an increase in the ability of the detector to detect high count rates without reaching saturation. By way of non-limiting example, while conventional single channel pulse counting detectors can typically reach saturation at count rates of about 4 million counts per second to about 5 million counters per second, some embodiments of the single channel pulse counting detector 114 illustrated in FIGS. 2 and 3 can handle count rates in the range of about 20 million counts per second to about 25 million counts per second without reaching saturation. A person skilled in the art will recognize that increasing a number of channels in a pulse counting detector can increase the count rate of the detector. Thus, by way of further non-limiting example, while conventional six channel pulse counting detectors can handle count rates in the range of about 24 million counts per second to about 30 million counts per second, some embodiments of a six channel pulse counting detector in accordance with applicants' teachings can handle count rates in the range of about 144 million counts per second to about 180 million counts per second. Accordingly, in some embodiments, the transimpedance amplifier 198 allows for a high dynamic range and can increase a range by a factor of about five for single and multiple channel detectors.

The voltage signal outputted by the transimpedance amplifier 198 can be delivered to subsequent stages of signal processing (not shown), including subsequent amplifications stages, as well as to an output device (not shown). In various embodiments the output device can comprise a computer and an external display. In some embodiments, of an output device the display can be provided by a computer with a screen associated therewith so that one or more desired parameters resulting from the output signal can be displayed. Alternatively, in some embodiments, an output device can comprise a printer so that one or more desired parameters resulting from the output signal can be displayed on a medium by the printer.

In some embodiments, when the system is being operated in a pulse counting mode, the pulse outputted by the transimpedance amplifier 198 can be inputted into a discriminator (not shown) configured to determine if an ion count has occurred. In some embodiments, the discriminator can compare the pulse from the transimpedance amplifier 198 to a threshold pulse value, and if the pulse from the transimpedance amplifier 198 exceeds the threshold pulse value, the discriminator can generate a signal that corresponds to one ion count. That signal can be delivered to subsequent stages of signal processing and/or to an output device. The number of ion counts received during a specified period of time, sometimes referred to as the dwell time, can be counted and subsequently turned into the “count rate” by the subsequent stages of signal processing and/or an output device. The count rate can correspond to the intensity of the analyte signal.

As shown in the illustrative embodiment, a resistor 199 can be included to help match the output impedance of the transimpedance amplifier 198 to an input impedance of a subsequent stage of signal processing and/or an output device. By way of example, in various embodiments the resistor 199 can have a resistance in the range of about 10 ohms to about 200 ohms, and in some embodiments, for instance the embodiment illustrated in FIGS. 2 and 3, the resistor 199 can have a resistance of about 50 ohms, though other resistances can be used for this and for other purposes. The resistor 199 or other components downstream of the transimpedance amplifier 198 can be optimized so that the circuit can easily communicate with subsequent stages of signal processing and/or output devices.

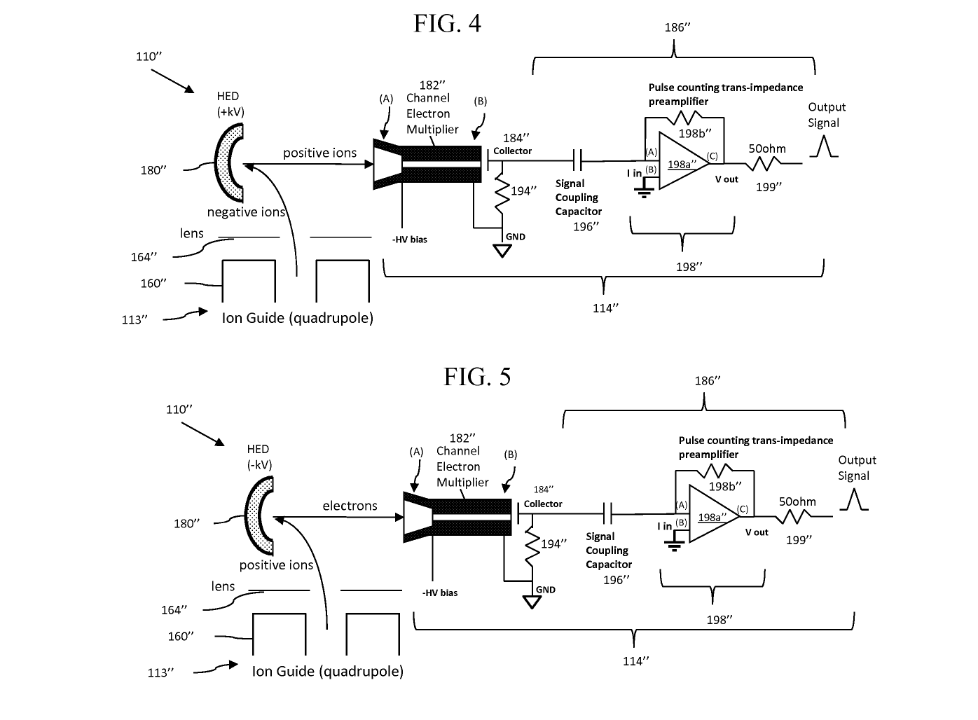

FIGS. 4 and 5 illustrate a detector 114″ according to another embodiment of the applicants' teachings, e.g., for use as part of a mass spectrometer 110″ in which a mass analyzer 113″ comprises one or more quadrupoles, represented by at least quadrupole 160″. As shown, the illustrative detector 114″ can comprise an electron multiplier 182″ for receiving positive or negative ions. In this illustrative embodiment, the ions exiting the last quadrupole 160″ are focused via a lens 164″ and are directed to a high energy conversion dynode (HED) 180″ comprising an HED electrode to generate positive ions or electrons in response to impact of negative ions or positive ions, respectively, thereon. The HED 180″ can be part of the detector 114″, or it can be implemented as a separate component disposed between the mass analyzer 113″ and the detector 114″. The ions can be extracted from the mass analyzer 113″ in a number of different ways, but in this illustrative embodiment, RF and DC voltages are applied to the last quadrupole 160″ to determine what masses of the ions will be transmitted out of the quadrupole 160″ and to the detector 114″. The DC-to-RF ratio can be roughly constant for all masses, with the DC voltage being able to be tweaked to give unit resolution at all masses when scanning at unit resolution, and then the mass spectrum can be created by ramping the magnitudes of the RF and DC voltages applied to the last quadrupole 160″, which can increase with mass, to produce a mass spectrum as a function of RF amplitude that correlates to time. A faster scan speed can mean ramping the RF and DC voltages faster as well. In some embodiments, the quadrupole 160″ can be configured for mass-selective axial ejection, with the different streams of ions being generated sequentially during scanning of applied auxiliary AC and/or RF confinement fields.

As discussed above, the polarity of the HED 180″ can be selected (i.e., either positive or negative) based on the polarity of ions to be detected. As shown in FIG. 4, negative ions exiting the last quadrupole 160″ can be transmitted toward the HED 180″ to strike the HED electrode that is maintained at a high positive potential, e.g., in a range of about +5 kV to about +20 kV, though other voltages can also be used. The impact of the negative ions on the HED electrode can cause emission of secondary particles in the form of positive ions, which are directed to a channel electron multiplier (CEM) or continuous dynode detector 182″.

As shown in FIG. 5, positive ions exiting the last quadrupole 160″ can be transmitted toward the HED 180″ to strike the HED electrode that in this case is maintained at a high negative potential, e.g., in a range of about −5 kV to about −20 kV, though other voltages can also be used. The impact of the positive ions on the HED electrode can cause emission of secondary particles in the form of electrons and/or negative ions, which can be directed to the CEM 182″.

The CEM 182″ can be biased for generating a current signal in response to incident positive ions or electrons/negative ions, respectively. In the embodiments shown in FIGS. 4 and 5, a high voltage (HV) is applied to the input end (A) of the CEM 182″ and the output end (B) of the CEM 182″ is grounded. In some embodiments, a bias voltage in a range of about 1 kV to about 3 kV can be applied across the CEM 182″. Although in the embodiments shown in FIGS. 4 and 5 a CEM is employed, in other embodiments other types of electron multipliers can be employed. Similar to the previous embodiment, a collector 184″ receives the shower of electrons generated by the CEM 182″ to generate a current signal (e.g., in the form of series of current pulses). In this illustrative embodiment, a resistor 194″ can be provided in series with the collector 184″, where one end of the resister is coupled to the collector and its other end is grounded. The resistor 194″ can drain the total charge accumulated by the collector 184″ to ground.

A voltage signal generator 186″ can receive the current signal generated by the collector 184″ and can generate a voltage signal based on the current signal. The signal generator 186″ can comprise a transimpedance amplifier 198″ that is capacitively coupled via a signal coupling capacitor 196″ to the collector 184″. As the output end (B) of the CEM 182″ is grounded in the illustrative embodiments of FIGS. 4 and 5, the capacitor 196″ does not necessarily need to be a high voltage capacitor. The capacitor 196″ can, nevertheless, act as a filter and can help protect the circuit by limiting the amount of energy that is discharged to the transimpedance amplifier 198″ should the energy levels rise above desired levels.

The transimpedance amplifier 198″ can generally operate in a similar manner as described above with respect to the transimpedance amplifier 198 of FIGS. 2 and 3 to convert the current signal it receives via capacitive coupling to the collector into a voltage signal. Further, similar to the previous embodiments, a voltage signal generated at the output of the transimpedance amplifier can be applied to downstream circuits, signal processing, and/or output devices, such as additional amplification stages, computers, and/or display units. By way of non-limiting example, as shown, a resistor 199″ can couple the voltage signal generated by the transimpedance amplifier 198″ to the subsequent circuits, signal processing, and/or output devices and can help match the output impedance of the transimpedance amplifier 198″ with an input impedance of the next stage of signal processing. In some embodiments, the use of the transimpedance amplifier 198″ allows the bias and gain of the CEM 182″ to be reduced, thereby increasing its dynamic range and its lifetime.

Aspects of the applicants' teachings may be further understood in light of the following examples, which should not be construed as limiting the scope of the applicants' teachings in any way.

FIG. 6 illustrates measured data corresponding to detection of ions of Reserpine having an m/z ratio of 609.23 in an AB Sciex QTrap® 5500 System mass spectrometer by using a detector similar to that shown in FIG. 2 utilizing a transimpedance amplifier (solid circles) in accordance with applicants' teachings as well as respective ion detection data obtained for these ions using a continuous dynode detector with a conventional ×20 voltage amplifier (open circles). The measured signal intensity that is calculated from an observed or measured count rate (i.e., the number of detector pulses that are counted by the system) is illustrated on the y-axis and is corrected for system dead time. For the illustrated data, the dead time correction is based upon a paralyzable counting system utilizing a dead time of about 19.5 nanoseconds. The measured signal intensity is equal to the true count rate when no detector saturation occurs (i.e., the number of detector pulses that should result from ions having an m/z ratio of about 609.23), and is illustrated by the dashed line designated as “Measured=True.” The true count rate in the illustrated embodiment, provided on the x-axis, was found by dividing the measured signal intensity of the fourth isotope, which had an m/z ratio of about 612.23, by its isotopic ratio found at low count rates. One skilled in the art will recognize that if no saturation occurs, then the intensity of the first isotope, i.e., the isotope having an m/z ratio of about 609.23, will equal the true count rate represented by the dashed line. Thus, the plot shown by the dashed line illustrates a line having a slope of approximately 1 such that the true count rate is approximately equal to a measured count rate, i.e., there is essentially no saturation in the system. This dashed line is used to compare the deviation of the measured count rates (i.e., the count rates obtained in presence and absence of the transimpedance amplifier) with the true count rate.

As shown in FIG. 6, the use of a transimpedance amplifier in accordance with the applicants' teachings can improve the dynamic range of ion detection. The data shows that in this example a measured count rate in a range of about 25 million counts per second to about 30 million counts per second can be achieved by using a transimpedance amplifier, whereas the maximum measured count rate achieved in this example by the conventional detection system does not even reach about 8 million counts per second.

Further, the data of FIG. 6 illustrates that the use of a transimpedance amplifier in accordance with the applicants' teachings can improve the accuracy of the measured count rate. For example, the deviation of data corresponding to the measured count rate with the detection system utilizing a transimpedance amplifier relative to the dashed line is much less than the respective deviation of data obtained by the conventional detection system. As shown, the measured count rate for the conventional detection system deviates from the “Measured=True” dashed line at much lower count rates and exhibits a higher deviation than that observed for the detection system utilizing a transimpedance amplifier. Without being limited by any particular theory, the deviation of the measured count rates from the “Measured=True” dashed line can be attributed to saturation effects of the respective systems, and the data illustrates that saturation effects can be significantly less when a transimpedance amplifier is incorporated in the detection system in accordance with the applicants' teachings.

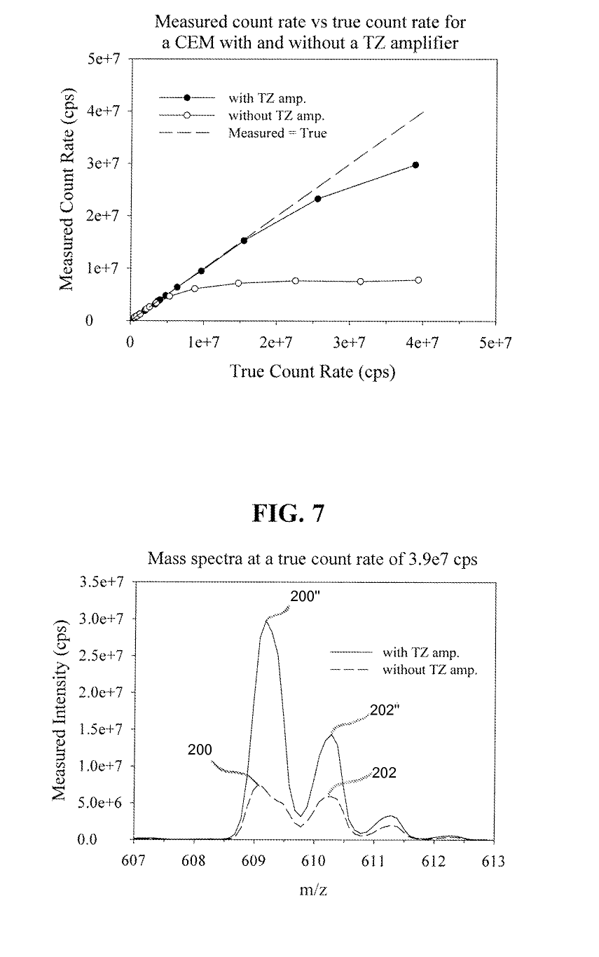

FIG. 7 shows a plot of the mass spectral data illustrating four isotopic peaks of Reserpine, where the true count for the highest peak is about 3.9 million counts per second. Like the plot in FIG. 6, the measured signal intensity is corrected for system dead time. For the illustrated data, the dead time correction is based upon a paralyzable counting system utilizing a dead time of about 19.5 nanoseconds.

The data depicted by the solid curve was obtained by using an AB Sciex QTrap® 5500 System mass spectrometer and utilizing a detection system based on the embodiment of FIG. 2 in which a transimpedance amplifier was employed in accordance with the applicants' teachings. The data depicted by the dashed line was obtained by using the same mass spectrometer but with a conventional detection system comprising a continuous dynode detector with a conventional ×20 voltage amplifier (i.e., without employing a transimpedance amplifier).

The data of FIG. 7 shows that the use of the detection system incorporating the transimpedance amplifier can result in increased dynamic range. For example, while the solid line peaks 200″ and 202″ exhibit different heights indicative of different concentrations of the two isotopes having m/z ratios of about 609.23 and about 610.23, the dashed line peaks 200 and 202 corresponding to these two isotopes have substantially similar heights (they are within about 1 million counts per second of each other). The data also indicates that the transimpedance amplifier can increase the dynamic range of the system. As shown, the solid first peak 200″ illustrates a measured intensity or count rate of about 30 million counts per second for the first isotope having a true count rate of about 39 million counts per second, as opposed to the dashed first peak 200, which has a measured intensity or count rate of about 7.5 million counts per second for the same true count rate.

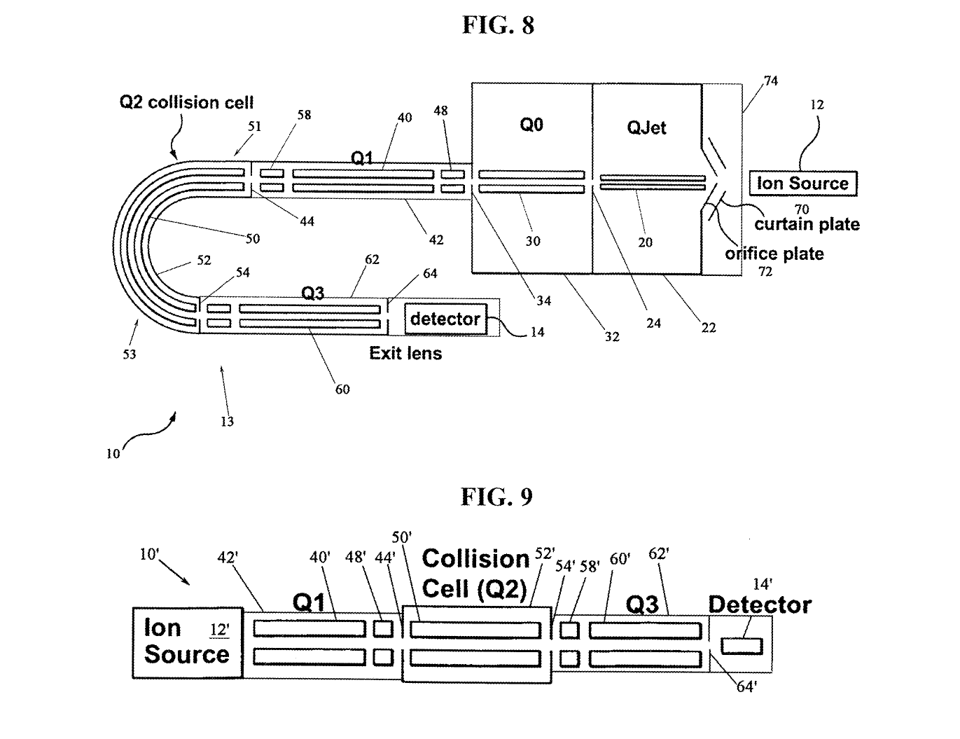

The systems, devices, and methods described herein can be used in conjunction with many different mass spectrometry systems. While FIG. 1 provides a general framework of some mass spectrometers with which applicants' teachings can be used, FIGS. 8 and 9 provide some further details of some such spectrometers. Aspects of the applicants' teachings may be further understood in light of the examples associated with FIGS. 8 and 9, but such embodiments should not be construed as limiting the scope of the applicants' teachings in any way. A person skilled in the art will understand a variety of configurations in which mass spectrometers, as well as components thereof, e.g., mass analyzers and detectors, can be used in accordance with applicants' teachings.

FIG. 8 illustrates one non-limiting embodiment of a triple quadrupole mass spectrometer 10. As shown, the mass spectrometer 10 comprises an ion source 12, a detector 14, and a mass analyzer 13 that comprises one or more quadrupoles 20, 30, 40, 50, 60 located upstream of the detector 14. The quadrupoles 20, 30, 40, 50, 60 can be disposed in adjacent chambers 22, 32, 42, 52, 62 that can be separated, for example, by lenses 24, 34, 44, 54. Alternatively, in some embodiments, one or more of the quadrupoles, for instance, by way of non-limiting example the Q1 quadrupole 40 and the Q3 quadrupole 60, can be located in the same chamber, as can the one or more lenses. In some embodiments, a chamber comprising the Q1 quadrupole 40 and the Q3 quadrupole 60 can further comprise the detector 14. Including multiple components in a single chamber can result in reducing the number of pumps used in conjunction with the spectrometer.

The ion source 12 can be an electrospray source, but it is understood that the ion source 12 can also be any other suitable ion source. For example, the ion source 12 can be a continuous ion source, a pulsed ion source, an inductively coupled plasma (ICP) ion source, a matrix-assisted laser desorption/ionization (MALDI) ion source, a glow discharge ion source, an electron impact ion source, or a photo-ionization ion source, among others.

Once emitted from the ion source 12, ions can optionally be extracted into a coherent ion beam by passing successively through apertures in a curtain or sampler plate 70 and an orifice or skimming plate (“skimmer”) 72, which can be housed in a vacuum chamber 74 configured to be evacuated by a mechanical pump to achieve desired pressures. The ion extraction provided by the sampler plate 70 and skimmer 72 can result in a narrow and highly focused ion beam. In some embodiments, additional vacuum chambers, plates, skimmers, and pumps can be utilized, for example, to provide additional focusing of and finer control over the ion beam.

Ions emitted from the ion source 12, whether they pass through one or more sampler plates or skimmers, can pass through one or more quadrupoles. The one or more quadrupoles can be situated in one or more chambers associated with one or mechanical pumps such that the pumps can be operable to evacuate the one or more chambers to desired pressure ranges. Typically, the pressure within each chamber increases with each successive quadrupole. Although the illustrated embodiment uses quadrupoles, hexapoles, octapoles, or other poles and/or ring guides of this nature can also be used.

As shown, ions emitted from the ion source 12 pass through five quadrupoles 20, 30, 40, 50, 60, each disposed in a chamber 22, 32, 42, 52, 62, respectively, with each chamber being separated by a respective lens 24, 34, 44, 54. As discussed above, in some other embodiments, one or more components, including any one of the quadrupoles 20, 30, 40, 50, 60 and lenses 24, 34, 44, 54, can be disposed in the same chamber. The quadrupoles 20, 30, 40, 50, 60 can be configured to perform a variety of functions for a variety of purposes, depending on, at least, the mass being analyzed and the desired parameters being measured. Thus, any description of how a particular quadrupole is used in conjunction with the described embodiments in no way limits the use of applicants' teachings with any number of quadrupoles performing any number of functions.

In some embodiments, the QJet® quadrupole 20 can be used to improve the sensitivity of the spectrometer 10 so that it can reach low limits of detection by capturing and focusing ions using a combination of gas dynamics and radio frequency fields. In some embodiments, the Q0 quadrupole 30 can be configured for operation as a collision focusing ion guide, for instance by collisionally cooling ions located therein. In some embodiments, the Q1 quadrupole 40 can be used to select ions of interest, sometimes referred to as precursor ions. By way of non-limiting example, the Q1 quadrupole can be operated as an ion trap by maintaining the lens 44 an ion optic or stubby rods 58 at a higher offset potential than the Q1 quadrupole 40. In some embodiments, the Q2 quadrupole 50 can be operated as part of a pressurized compartment or collision chamber 52. As shown, the Q2 quadrupole 50 can be a J-shaped curved collision cell and can comprise a straight section or portion 51 and a curved section or portion 53.

The Q3 quadrupole 60 can likewise be operated in a number of manners, for example as a scanning RF/DC quadrupole or as a linear ion trap, to mass-selectively scan ions trapped in the quadrupole 60 to the detector 14 for mass-differentiated detection. Some non-limiting examples of how the Q3 quadrupole 60 can be configured and operated are described in more detail in U.S. Pat. No. 6,177,668, entitled “Axial Ejection in a Multipole Mass Spectrometer,” and which is hereby incorporated by reference in its entirety.

Optionally, one or more RF-only ion guides or stubby rods can be included to facilitate the transfer of ions between quadrupoles. The stubby rods can serve as a Brubaker lens and can help prevent ions from undergoing orbital decay due to interactions with any fringing fields that may have formed in the vicinity of the adjacent lens, for example, if the lens is maintained at an offset potential. As shown, first stubby RF-only ion guides or stubby rods 48 are provided between the Q0 quadrupole 30 and the Q1 quadrupole 40, and second stubby RF-only ion guides or stubby rods 58 are provided between the Q1 quadrupole 40 and the Q2 quadrupole 50. Although both stubby rods 48 and 58 are illustrated as being part of the chamber 42 in which the Q1 quadrupole 40 is located, in various other embodiments the stubby rods 48 and 58 can be situated in other locations. By way of non-limiting examples, the stubby rods 58 can be in the collision chamber 52, before the Q2 quadrupole 50, or the stubby rods 48 can be located in the chamber 32, after the Q0 quadrupole 30.

Analyte ions from the chamber 62, which can comprise both product and precursor ions, can be transmitted into the detector 14 through the exit lens 64 so that the ions can be detected. The detector can then be operated in a manner known to those skilled in the art in view of the present systems, devices, and methods. Some examples of how detectors can be operated are provided above with respect to FIGS. 1-5, although such descriptions, as well as any descriptions that follow below, are in no way limiting of how the applicants' teachings can be applied to detectors.

By way of non-limiting example, the detector can comprise an electron multiplier in which the ions incident on the first of a series of electrodes held at progressively more positive electric potentials can cause emission of electrons from the first electrode, which are accelerated to a subsequent electrode to induce the emission of secondary electrons from that electrode with the secondary electron emission repeating at other electrodes to generate a shower of electrons. At least some of the electrons in the electron shower can be collected, for example, by a metal anode of the detector to generate an electrical signal indicative of the intensity of the ions. This electrical signal can be subsequently amplified, stored, and displayed as desired. Non-limiting examples of electron multipliers include discrete dynode secondary electron multipliers, which can use a series of dynodes (generally in the range of about 16 to about 25) in which each dynode can be maintained at a higher positive potential than the preceding one, and a channel electron multiplier (CEM) or continuous dynode electron multiplier, which can use a conducting surface to act as a continuous dynode as described, at least in part, above. As ions pass through the multipliers, the electrons can generally be reflected and advanced between surfaces of the respective dynodes (discrete dynode secondary electron multiplier) or conducting surface such the number of secondary electrons is amplified each time each electron strikes a surface. Generally, a CEM is more compact than a discrete dynode secondary electron multiplier. Alternatively, in some embodiments, a micro-channel plate detector can be used in place of a CEM and the applicants' teachings, such as those pertaining to a transimpedance amplifier, can be incorporated for use with such a detector.

FIG. 9 illustrates another non-limiting embodiment of a triple quadrupole mass spectrometer 10. As shown, the mass spectrometer 10′ comprises an ion source 12′, a detector 14′, and a mass analyzer 13′ that comprises a Q1 quadrupole 40′, a Q2 quadrupole 50′, and a Q3 quadrupole 60′, each of which is located upstream of the detector 14′. The quadrupoles 40′, 50′, 60′ can be disposed in adjacent chambers 42′, 52′, 62′ that can be separated, for example, by lenses 44′, 54′, and an exit lens 64′ can separate the Q3 quadrupole 60′ from the detector 14′. As shown, the spectrometer 10′ also comprises first stubby rods 48′ located between the Q1 quadrupole 40′ and the Q2 quadrupole 50′, in the chamber 42′, and second stubby rods 58′ located between the Q2 quadrupole 50′ and the Q3 quadrupole 60′, in the chamber 62′. While the quadrupoles 40′, 50′, 60′ of the spectrometer 10′ can operate in manners similar to the quadrupoles of the spectrometer 10, the collision cell 52′ that comprises the Q2 quadrupole 50′ is a straight collision cell rather than a curved collision cell like the cell 52 of the spectrometer 10.

Other non-limiting, exemplary embodiments of mass spectrometers that can be used in conjunction with the systems, devices, and methods disclosed herein can be found, for example, in U.S. Pat. No. 7,923,681, entitled “Collision Cell for Mass Spectrometer,” which is hereby incorporated by reference in its entirety. Other configurations, including but not limited to those described herein and others known to those skilled in the art, can also be utilized in conjunction with the systems, devices, and methods disclosed herein.

While the above description provides examples and specific details of various embodiments, it will be appreciated that some features and/or functions of the described embodiments admit to modification without departing from the scope of the described embodiments. The above description is intended to be illustrative of the invention, the scope of which is limited only by the language of the claims appended hereto. For example, while the teachings herein are described in conjunction with various embodiments, it is not intended that such teachings be limited to such embodiments. On the contrary, the teachings herein encompass various alternatives, modifications, and equivalents, as will be appreciated by those of skill in the art. All publications and references cited herein are expressly incorporated herein by reference in their entirety.

1. A detector for use in a mass spectrometer system, comprising:
an electron multiplier;
a collector disposed downstream of the electron multiplier and configured to receive an electron current from the electron multiplier to generate a current signal; and
a transimpedance amplifier electrically coupled to the collector for receiving the current signal and generating a voltage signal based on the current signal.

2. The detector of claim 1, wherein the transimpedance amplifier is configured to provide a non-unity gain.

3. The detector of claim 1, further comprising a coupling capacitor disposed between the collector and the transimpedance amplifier to capacitively couple the current signal to the amplifier.

4. The detector of claim 1, further comprising a high energy conversion dynode disposed upstream of the electron multiplier, the dynode being configured to discharge ions into the electron multiplier.

5. The detector of claim 1, wherein the current signal comprises a pulse current signal.

6. The detector of claim 1, further comprising a resistor disposed downstream of the transimpedance amplifier, the resistor being configured to match an impedance of an output device to an output impedance of the transimpedance amplifier.

7. A mass spectrometer system, comprising:
an ion source;
a mass analyzer configured to receive a plurality of ions from the ion source, a detector disposed downstream from the mass analyzer and configured to receive ions discharged from the mass analyzer, the detector comprising:
an ion detection module configured to receive at least a portion of the ions discharged by the mass analyzer and to generate a current signal in response to the received ions; and
a transimpedance amplifier electrically coupled to the ion detection module to receive the current signal and to convert the current signal into a voltage signal.

8. The mass spectrometer system of claim 7, wherein the transimpedance amplifier is configured to have a non-unity gain.

9. The mass spectrometer system of claim 7, wherein the detector is configured to operate in a pulse counting mode and is capable of operating at a pulse counting rate of up to about 20 million counts per second without saturation.

10. The mass spectrometer system of claim 7, wherein the ion detection module comprises an electron multiplier.

11. The mass spectrometer system of claim 7, wherein the ion detection module further comprises a high energy conversion dynode (HED) configured to receive the at least a portion of the ions discharged from the mass analyzer and to generate secondary ions and/or electrons in response to the received ions, the HED being in communication with the electron multiplier so as to direct the secondary ions and/or electrons to the electron multiplier.

12. The mass spectrometer system of claim 7, wherein the mass analyzer comprises a plurality of quadrupoles disposed downstream of the ion source to receive ions from the ion source.

13. In a mass spectrometer, a method for detecting ions, comprising;
introducing a plurality of ions discharged by a mass analyzer of the mass spectrometer into an electron multiplier to generate a pulsed current signal; and
feeding the pulsed current signal to a transimpedance amplifier so as to convert the pulsed current signal into a pulsed voltage signal.

14. The method of claim 13, wherein the channel electron multiplier comprises a plurality of channels.

15. The method of claim 13, wherein the electron multiplier comprises a discrete dynode detector.

16. The detector of claim 1, wherein the transimpedance amplifier is configured to have an adjustable gain.

17. The detector of claim 1, wherein the electron multiplier is configured to operate at a bias voltage in a range of about 1 kV to about 3 kV.

18. The mass spectrometer system of claim 7, wherein the transimpedance amplifier is configured to have an adjustable gain.

19. The method of claim 13, wherein the electron multiplier comprises a channel electron multiplier.
